(19) United States
(12) Patent Application Publication
(10) Pub. No.: US 2025/0304139 A1
(43) Pub. Date: Oct. 2, 2025

(54) FOLDABLE BABY WAGON

(71) Applicant: BRAN-NEW INTERNATIONAL CORPORATION, Seoul (KR)

(72) Inventor: Mijin KIM, Bucheon-si (KR)

(21) Appl. No.: 18/617,655

(22) Filed: Mar. 27, 2024

(51) Int. Cl. B62B 7/06; B62B 9/10; B62B 9/12; B62B 9/14

(52) U.S. Cl. CPC B62B 7/06; B62B 3/007; B62B 9/102; B62B 9/104; B62B 9/12; B62B 9/142

(57) ABSTRACT

A baby wagon which includes a foldable main body frame constituted by a front main frame, a rear main frame, and a side frame, wherein the shape of the frame constituting the baby wagon may be varied, whereby it is possible for a baby to maintain a comfortable posture in the baby wagon depending on physical conditions of the baby, such as age and physical growth of the baby, and therefore ride comfort and transportation stability may be improved, wherein a change in shape of the baby wagon through folding and unfolding of the baby wagon may be easily performed by a caregiver alone, and wherein the frame of the baby wagon may be stably fixed for easy carrying and storage in a baby wagon folding mode and a baby wagon usage mode.

### BACKGROUND

### Field of the Invention

The present invention relates to a baby wagon with improved ease of use.

The present invention relates to a baby wagon with improved ease of use that allows a caregiver to easily change the shape of the baby wagon depending on the situation.

The present invention relates to a baby wagon with improved ease of use capable of easily changing the sitting direction and the sitting posture of a baby, thereby improving ride comfort and transportation stability.

The present invention relates to a baby wagon with improved ease of use configured such that a frame is stably supported and fixed in a folded state of the baby wagon and such that the volume of the baby wagon is minimized.

### Description of the Related Art

A conventional baby wagon has a structural limitation to changing the shape thereof other than a folding mode and an unfolding mode, which makes it difficult for a baby to comfortably maintain a desired posture and easy for the baby to have bad posture.

In addition, the conventional baby wagon is configured to have a rectangular internal structure in which the baby is seated on the bottom of the baby wagon. As a result, stability of the baby in the baby wagon is low. Furthermore, when the baby wagon is moved over uneven ground, impact applied to front and rear wheels has a significant influence on the interior of the baby wagon, whereby the ride comfort of the baby in the baby wagon is lowered, making it difficult to maintain a stable ride for the baby in the baby wagon.

### PRIOR ART DOCUMENT

### Patent Document

(Patent Document 0001) Korean Registered Patent Publication No. 10-2415226 (registered on Jun. 27, 2022)

### SUMMARY

One or more embodiments of the present disclosure have been made in view of the above problems. One or more embodiments of the present disclosure may provide a baby wagon with improved ease of use configured such that the shapes of a frame and a seat are varied to change the sitting direction and the sitting posture of a baby.

One or more embodiments of the present disclosure may provide a baby wagon with improved ease of use configured such that a change in shape of the baby wagon through folding and unfolding of the baby wagon is easily performed by a caregiver alone.

One or more embodiments of the present disclosure may provide a baby wagon with improved ease of use configured such that a frame of the baby wagon is stably fixed for easy carrying and storage in a baby wagon folding mode and a baby wagon usage mode.

In accordance with one or more embodiments of the present disclosure, a baby wagon may include a foldable main body frame, a wagon wheel unit, a seat unit, and a canopy unit, the baby wagon serving as a baby transport means, wherein the foldable main body frame includes a front main frame having a quadrangular structure disposed at a front end of the foldable main body frame in an upright state, the front main frame being configured to support the front of the foldable main body frame, a rear main frame having a quadrangular structure disposed at a rear end of the foldable main body frame in an upright state, the rear main frame being configured to support the rear of the foldable main body frame, and a side frame coupled to the front main frame and the rear main frame through a symmetrical axial rotation structure therebetween so as to be supported thereby, the side frame being folded while being rotated about the axis.

### BRIEF DESCRIPTION OF THE DRAWINGS

The above and other objects, features and other advantages of the present invention will be more clearly understood from the following detailed description taken in conjunction with the accompanying drawings discussed briefly below.

FIG. 1 is a perspective view showing an overall shape of a baby wagon with improved ease of use according to an embodiment of the present disclosure.

FIG. 2 is an exploded perspective view showing components of the baby wagon with improved ease of use according to an embodiment of the present disclosure to which a wagon canopy unit is selectively coupled.

FIG. 3 is a perspective view showing an overall shape of the baby wagon with improved ease of use according to an embodiment of the present disclosure.

FIG. 4 is an exploded perspective view showing components of the baby wagon with improved ease of use according to an embodiment of the present disclosure to which a baby carrier canopy unit is selectively coupled.

FIG. 5 is an exploded perspective view showing an overall shape of a main body frame according to an embodiment of the present disclosure.

FIG. 6 is an exploded perspective view showing components of the main body frame according to an embodiment of the present disclosure.

FIG. 7 is a view showing the shape of a front main frame according to an embodiment of the present disclosure with a partial enlarged view showing a front upper end support fixture and a front center support fixture.

FIG. 8 is a view showing a part of the front main frame according to an embodiment of the present disclosure, wherein an embodiment in which a canopy fixing pole is inserted into and fixed to the front upper end support fixture and the front center support fixture is shown.

FIG. 9 is a view showing the shape of the front main frame according to an embodiment of the present disclosure with an exploded view of a front upper end horizontal frame and an enlarged view showing the interior of an end of the front upper end horizontal frame in a projected state.

FIG. 10 is a view showing the shape of a rear main frame according to an embodiment of the present disclosure with a partial enlarged view showing a rear upper end support fixture and a rear center support fixture.

FIG. 11 is a view showing a part of the rear main frame according to an embodiment of the present disclosure, wherein an embodiment in which a canopy fixing pole is inserted into and fixed to the rear upper end support fixture and the rear center support fixture is shown.

FIG. 12 is a view showing the shape of the rear main frame according to an embodiment of the present disclosure with an exploded view of a rear upper end horizontal frame and an enlarged view showing the interior of an end of the rear upper end horizontal frame in a projected state.

FIG. 13 is a side view showing the state in which the canopy fixing pole of the wagon canopy unit according to an embodiment of the present disclosure is coupled to the front upper end support fixture and the rear upper end support fixture, whereby the wagon canopy unit is fixed as high as the height of the canopy fixing pole.

FIG. 14 is a side view showing the state in which the canopy fixing pole of the wagon canopy unit according to an embodiment of the present disclosure extends through the front upper end support fixture and the rear upper end support fixture and is coupled to the front center support fixture and the rear center support fixture, whereby the wagon canopy unit is fixed as low as the height of the front center support fixture and the rear center support fixture from the front upper end support fixture and the rear upper end support fixture.

FIG. 15 is a perspective view showing the configuration of a foldable main body frame, a wagon wheel unit, and a seat unit according to an embodiment of the present disclosure, showing the state in which a tray unit, a front chair seat unit, and a rear chair seat unit are coupled to the seat unit.

FIG. 16 is a perspective view showing the configuration of the foldable main body frame, the wagon wheel unit, and the seat unit according to an embodiment of the present disclosure, showing the state in which the front chair seat unit and the rear chair seat unit are coupled to the seat unit.

FIG. 17 is a side view showing the overall shape of the baby wagon according to an embodiment of the present disclosure, wherein an embodiment in which two babies are seated facing forward in a dual front seat mode in which the front chair seat unit is coupled so as to face forward and the rear chair seat unit is coupled so as to face forward is shown.

FIG. 18 is a side view showing the overall shape of the baby wagon according to an embodiment of the present disclosure, wherein an embodiment in which two babies are seated facing each other in a dual inner seat mode in which the front chair seat unit is coupled so as to face backward and the rear chair seat unit is coupled so as to face forward is shown.

FIG. 19 is a side view showing the overall shape of the baby wagon according to the present disclosure, wherein an embodiment in which two babies are seated facing outward with their backs to each other in a dual outer seat mode in which the front chair seat unit is coupled so as to face forward and the rear chair seat unit is coupled so as to face backward is shown.

FIG. 20 is a perspective view showing the configuration of the foldable main body frame, the wagon wheel unit, and the seat unit according to an embodiment of the present disclosure, wherein an embodiment in which the front upper end horizontal frame and the rear upper end horizontal frame are separated, the front chair seat unit is coupled so as to face forward, and the rear chair seat unit is coupled so as to face backward is shown.

FIG. 21 is a view showing the baby wagon according to an embodiment of the present disclosure with the front upper end horizontal frame and the rear upper end horizontal frame removed, wherein an embodiment in which the backrest angle of each of the front chair seat unit and the rear chair seat unit is adjusted through a backrest angle adjustment portion is shown.

FIG. 22 is side view showing the front chair seat unit and the rear chair seat unit according to an embodiment of the present disclosure, wherein an embodiment in which a switch of the backrest angle adjustment portion is maintained closed in the state in which an angle adjustment belt is pulled and the backrest of each of the front chair seat unit and the rear chair seat unit is erected is shown.

FIG. 23 is a side view showing the front chair seat unit and the rear chair seat unit according to an embodiment of the present disclosure, wherein an embodiment in which the switch of the backrest angle adjustment portion is opened, and the angle adjustment belt is introduced into the backrest angle adjustment portion and is loosened to allow the backrest of each of the front chair seat unit and the rear chair seat unit to lie down is shown.

FIG. 24 is a side view showing an overall shape of the baby wagon according to an embodiment of the present disclosure, wherein an embodiment in which the front upper end horizontal frame and the rear upper end horizontal frame are separated, the front chair seat unit is closely coupled to the front facing forward, the rear chair seat unit is closely coupled to the rear facing backward, and front and rear upper ends of the seat unit are open such that babies are seated with legs outstretched in an outward direction is shown.

FIG. 25 is a perspective view showing the configuration of the foldable main body frame, the wagon wheel unit, and the seat unit according to an embodiment of the present disclosure, wherein an embodiment in which, when a zipper formed at front and rear sides of a bottom surface of the seat unit in a transverse direction is opened, a standing chair forming unit is formed while being unfolded downward is shown.

FIG. 26 is a perspective view showing the configuration of the foldable main body frame, the wagon wheel unit, and the seat unit according to an embodiment of the present disclosure, wherein an embodiment in which, when the zipper formed at the front and rear sides of the bottom surface of the seat unit in the transverse direction is closed, a sitting chair forming unit having a flat bottom surface is formed is shown.

FIG. 27 is a side view showing the overall shape of the baby wagon according to an embodiment of the present disclosure, wherein an embodiment in which the standing chair forming unit is formed as the result of the zipper formed at the bottom surface of the seat unit being opened and two babies are seated facing each other in a standing mode is shown.

FIG. 28 is a side view showing a folded shape of the baby wagon according to an embodiment of the present disclosure.

### DETAILED DESCRIPTION

Embodiments of the present disclosure will be described with reference to the accompanying drawings.

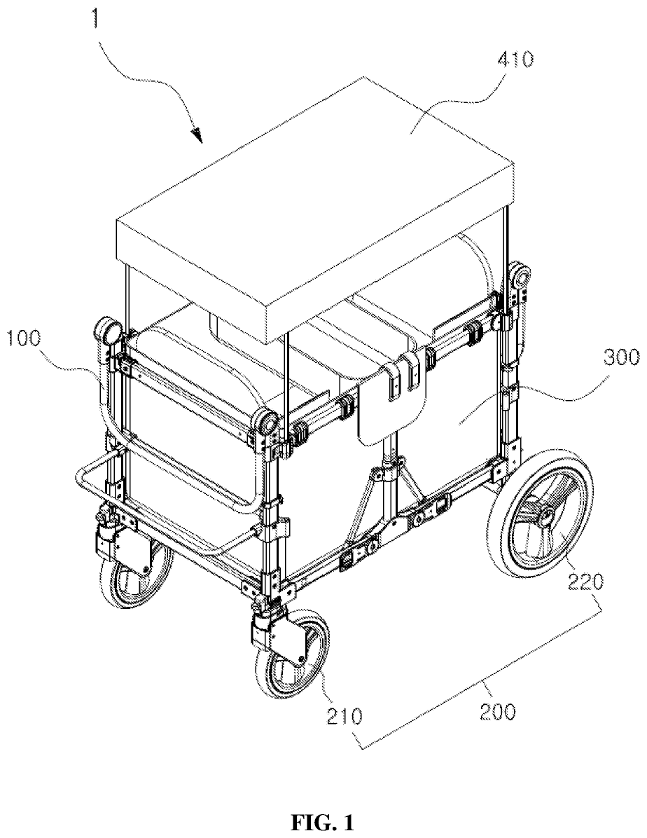

FIG. 1 is a perspective view showing the overall shape of a baby wagon 1 with improved ease of use according to an embodiment of the present disclosure. The baby wagon includes a foldable main body frame 100, a wagon wheel unit (wagon wheel assembly) 200, a seat unit (seat assembly) 300, and a canopy unit (canopy assembly) 400. The wagon wheel unit (wagon wheel assembly) 200 includes at least one front wheel unit (front wheel assembly) 210 and at least one rear wheel unit (rear wheel assembly) 220.

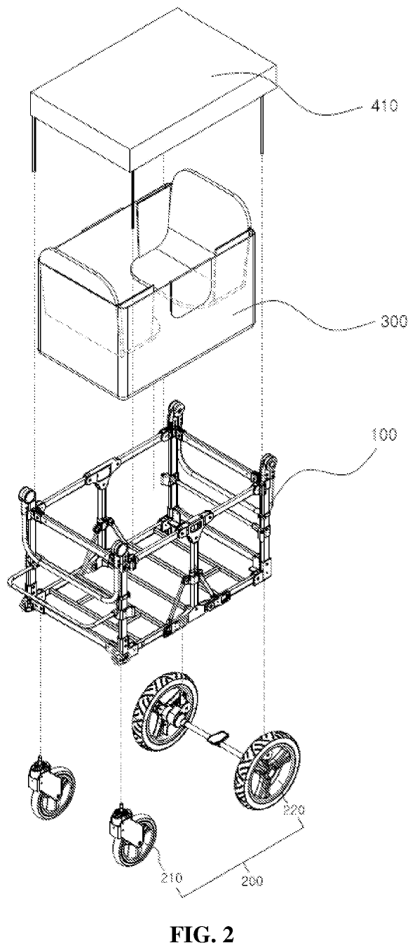

FIG. 2 is an exploded perspective view showing components of the baby wagon with improved ease of use according to an embodiment of the present disclosure to which a wagon canopy unit is selectively coupled.

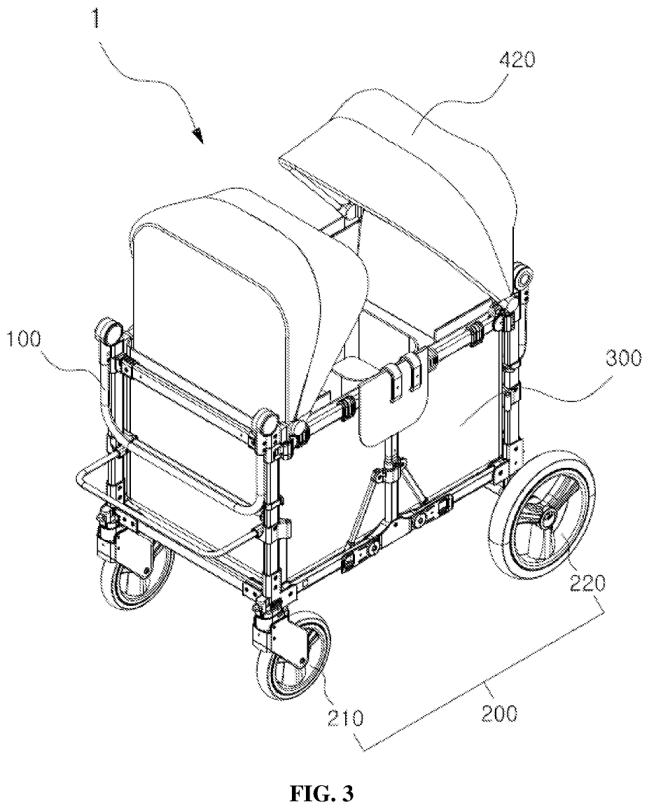

FIG. 3 is a perspective view showing the overall shape of the baby wagon with improved ease of use according to an embodiment of the present disclosure.

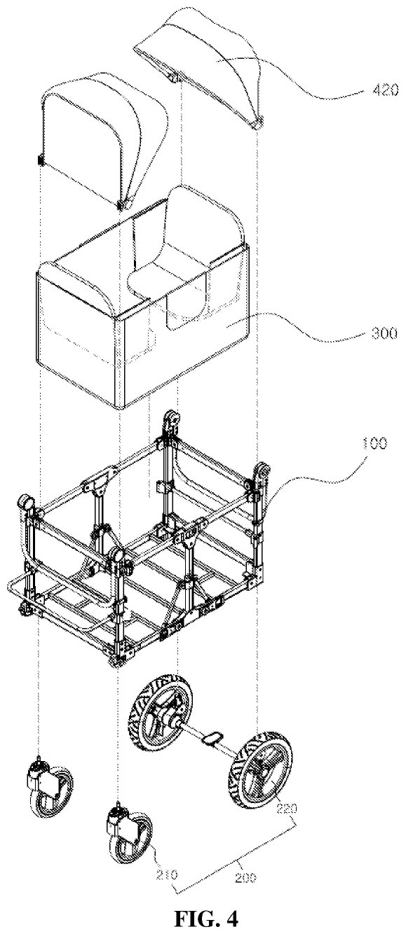

FIG. 4 is an exploded perspective view showing components of the baby wagon with improved ease of use according to an embodiment of the present disclosure to which a baby carrier canopy unit is selectively coupled.

Hereinafter, the foldable main body frame 100 according to an embodiment of the present disclosure will be described.

The foldable main body frame 100, which is a cuboidal frame, is formed so as to support the entirety of the main body of the baby wagon 1, and is configured such that a central part of the foldable main body frame 100 is folded or unfolded in a forward-rearward direction, whereby the shape of the foldable main body frame 100 is changed.

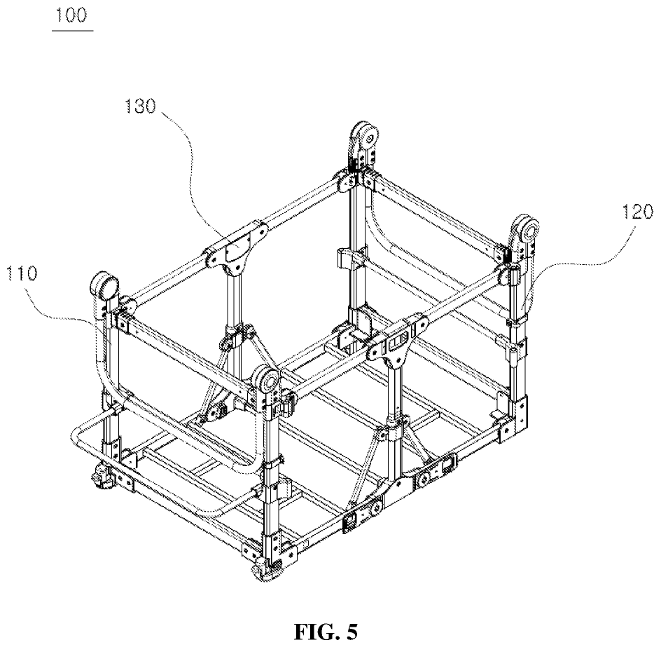

The foldable main body frame 100 according to an embodiment of the present disclosure includes a front main frame 110, a rear main frame 120, and a side frame 130 as shown in FIG. 5.

First, the front main frame 110 according to an embodiment of the present disclosure will be described.

The front main frame 110, which is a frame having a quadrangular structure disposed at the front end of the foldable main body frame 100 in an upright state, supports the front of the foldable main body frame 100.

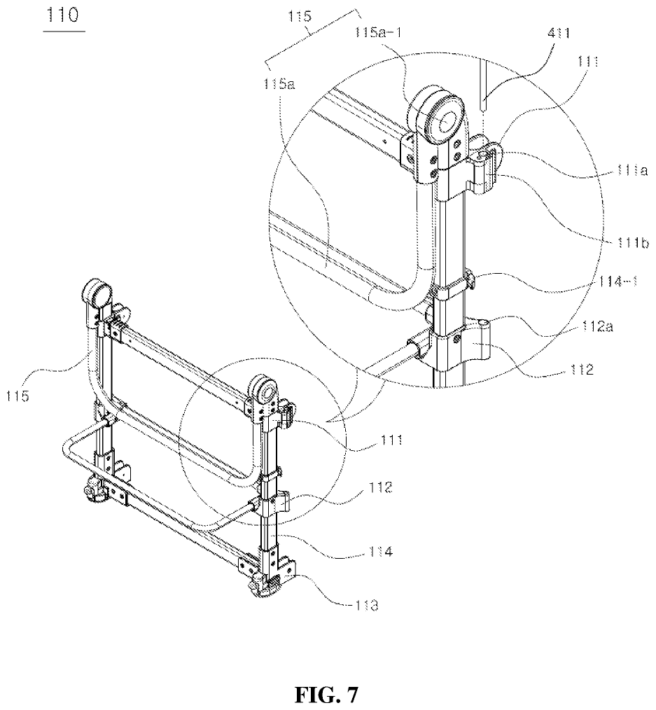

FIGS. 7, 8, and 9 show a front main frame 110 includes a front upper end support fixture 111, a front center support fixture 112, a front lower end support fixture 113, a front main support frame 114, and a front handle frame 115.

The front upper end support fixture 111 is formed at each of left and right sides of an upper end of the front main frame 110 in a symmetrical fashion, and one side of the rear of the front upper end support fixture 111 is coupled to an upper front end of the side frame 130 through an axial structure to support the front main frame 110.

The front upper end support fixture 111 according to an embodiment of the present disclosure is configured such that a pole through-hole 111a is formed through one side of an outer part thereof in a vertical direction, a rotation locking switch 111b is formed at one side of an outer surface thereof, and a switch protrusion 111b-1 of the rotation locking switch 111b is detached from and coupled to a switch fixing recess 111a-1 connected to the pole through-hole 111a, whereby a canopy fixing pole 411 of canopy 400 inserted thereinto is fixed and separated.

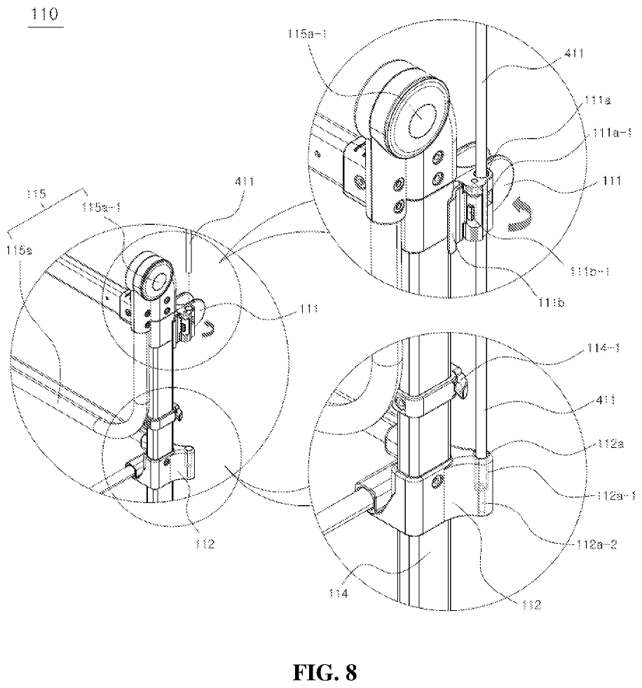

The pole through-hole 111a is a hole that is formed perpendicularly through one side of an upper end surface of the front upper end support fixture 111 in an outward direction, and is configured such that the switch fixing recess 111a-1 (FIG. 8) connected to the pole through-hole 111a is formed at one side thereof in the outward direction, whereby the switch protrusion 111b-1 located inside the rotation locking switch 111b is detached therefrom and coupled thereto, and the canopy fixing pole 411 is inserted thereinto in the vertical direction.

The rotation locking switch 111b is configured such that a rotation shaft is formed at one side of the front upper end support fixture 111 in the vertical direction, a handle configured to be rotated about the rotation shaft is formed at one side of an outer surface thereof, and the switch protrusion 111b-1 is formed at one side of an inner surface of the handle so as to protrude in an inward direction.

When the rotation locking switch 111b is pushed so as to come into contact with the outer surface of the front upper end support fixture 111, the switch protrusion 111b-1 is coupled to the switch fixing recess 111a-1, and the side surface of the canopy fixing pole 411 inserted into the pole through-hole 111a is supported, whereby the canopy unit 400 is fixed. When the rotation locking switch 111b is pulled so as to be spaced apart from the outer surface of the front upper end support fixture 111, the switch protrusion 111b-1 is detached from the switch fixing recess 111a-1 and is spaced apart from the canopy fixing pole 411 inserted into the pole through-hole 111a, whereby the canopy unit 400 is separated.

The canopy fixing pole 411 may be easily locked or unlocked, the height fixed position of the canopy unit 400 may be changed, and the canopy unit 400 may be easily detached and coupled by pushing or pulling the rotation locking switch 111b about the rotation shaft of the rotation locking switch 111b.

The front center support fixture 112 is formed at each of left and right sides of the center of the front main frame 110 in a symmetrical fashion, and a step through-hole 112a, which has a circular step, is formed through one side of an outer part thereof in the vertical direction.

The step through-hole 112a is a hole that is located at one side of the front center support fixture 112 in the outward direction and is formed to be aligned with the pole through-hole 111a in the vertical direction. The step through-hole 112a is configured such that an upper end circular step 112a-1, into which a lower end of the canopy fixing pole 411 can be inserted so as to be supported thereby, is formed at an upper end of the step through-hole 112a, and is configured such that a lower end through-hole 112a-2 is formed in a lower end of the center of the upper end circular step 112a-1.

The lower end of the canopy fixing pole 411 is inserted into and supported by the upper end circular step 112a-1 of the step through-hole 112a when the canopy fixing pole 411 is lowered to form a lower end sunshade mode.

If foreign matter is introduced into the upper end circular step 112a-1, the foreign matter may be easily discharged through the lower end through-hole 112a-2 of the step through-hole 112a, thereby facilitating cleaning management and ensuring that the canopy fixing pole 411 can be stably seated.

The front lower end support fixture 113 is formed at each of left and right sides of the lower end of the front main frame 110 in a symmetrical fashion. One side of the rear of the front lower end support fixture 113 is coupled to a lower front end of the side frame 130 through an axial structure so as to be supported thereby. A front wheel unit (front wheel assembly) 210 is coupled vertically upward to one side of the lower end of the front lower end support fixture 113, whereby the front wheel unit 210 is supported thereby.

The front main support frame 114, which is a frame coupled to the front upper end support fixture 111 and the front lower end support fixture 113, which are formed in left-right symmetry, so as to have a quadrangular shape, serves to support the entirety of the front main frame 110.

A folding locking protrusion 114-1 is formed at one side of each of left and right side surfaces of the front main support frame 114 in a symmetrical fashion.

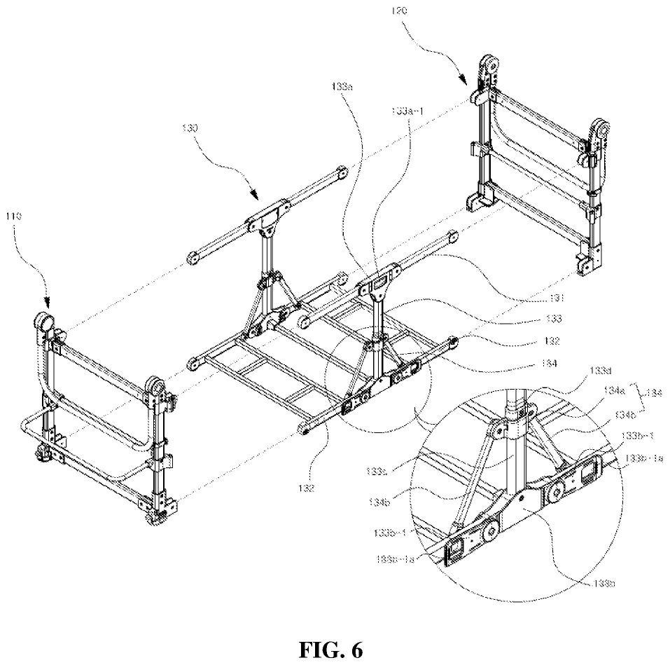

Referring to FIGS. 6-7, the folding locking protrusion 114-1 is located so as to be inserted into and coupled to a protrusion insertion recess 133b-1a of a folding locking bar 133b-1 protruding forward in the outward direction as a lower end central axis support fixture 133b of the side frame 130 is moved upward when the mode of the foldable main body frame 100 is switched to a folding mode.

When the mode of the foldable main body frame 100 is switched to the folding mode, therefore, the folding locking protrusion 114-1 is inserted into and fixed to the protrusion insertion recess 133b-1a located at the folding locking bar 133b-1 of the side frame 130, thereby preventing the foldable main body frame 100 from being unfolded unintentionally by the user, and therefore it is possible to stably store or move the baby wagon 1 in the folding mode and to minimize the volume of the baby wagon 1.

In addition, the front main support frame 114 according to an embodiment of the present disclosure is provided at an upper end thereof with a front upper end horizontal frame 114a, which is supported in a horizontal state.

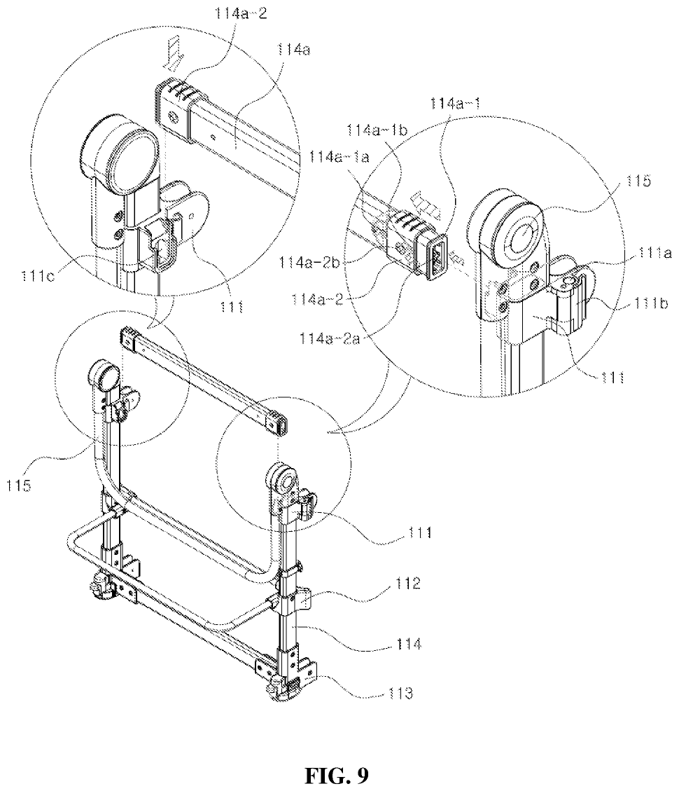

Referring to FIG. 9, the front upper end horizontal frame 114a is a frame coupled to left and right inner surfaces of the front upper end support fixture 111 so as to support the front upper end support fixture 111 in a horizontal state, is coupled to and separated from the front upper end support fixture 111 through a sliding structure, is configured to be switched to a front exposed seat mode, and is provided with an inner fixed frame 114a-1 and a slide frame 114a-2.

The inner fixed frame 114a-1 is a frame inserted into and fixed to left and right ends of the front upper end horizontal frame 114a, a spring 114a-1a is laid down in the inner fixed frame 114a-1 in a leftward-rightward direction in the state in which one side of the spring 1141-1a is fixed and the other side of the spring is in contact with the slide frame 114a-2 so as to have elasticity, and a long hole 114a-1b, which is a long hole formed in the leftward-rightward direction, is formed so as to receive a side protrusion 114a-2b moved according to the leftward-rightward movement of the slide frame 114a-2.

The slide frame 114a-2 is a frame formed on peripheries of the left and right sides of the front upper end horizontal frame 114A, wherein one side of the interior of the slide frame 114a-2 is inserted into the inner fixed frame 114a-1, and is configured such that an insertion protrusion 114a-2a engaged with an inner recess 111c of the front upper end support fixture 111 so as to be detached therefrom and be coupled thereto is formed at each of the left and right ends thereof and such that the side protrusion 114a-2b protrudes from each of the front and rear sides thereof through the long hole 114a-1b.

When each of the slide frames 114a-2 formed at the left and right sides is pulled inward, the side protrusion 114a-2b moves inward along the long hole 114a-1b, whereby the spring 114a-1a is compressed, and the insertion protrusion 114a-2a moves inward and is separated from the inner recess 111c of the front upper end support fixture 111, whereby the front upper end horizontal frame 114a is detached therefrom. In order to couple the front upper end horizontal frame 114a, each of the slide frames 114a-2 formed at the left and right sides is pulled inward, the position of the slide frame 114a-2 is fixed at the inside of the front upper end support fixture 111, and the slide frame 114A-2 is released, whereby the insertion protrusion 114a-2a is inserted into the inner recess 111c of the front upper end support fixture 111, and therefore it is possible to couple the front upper end horizontal frame 114a.

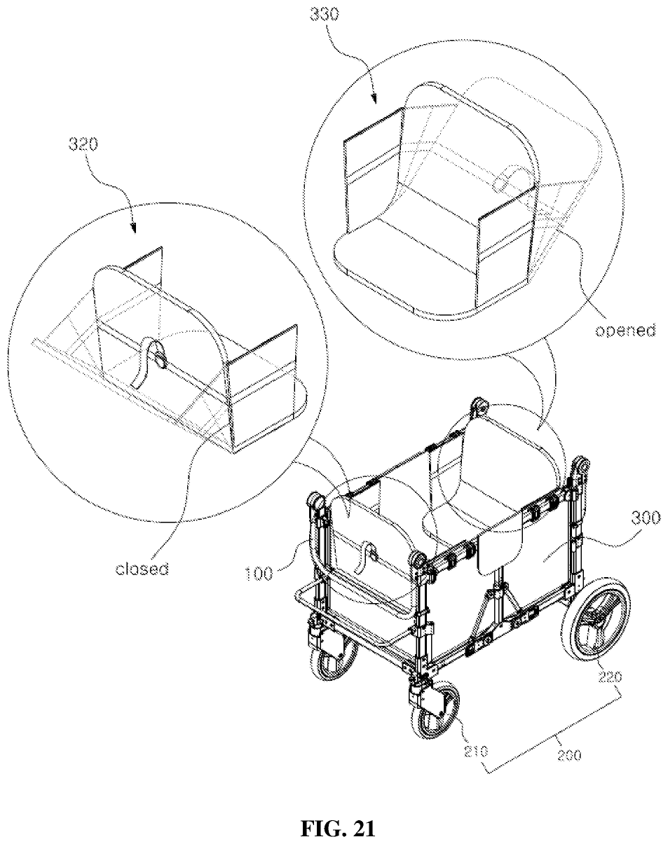

When the front upper end horizontal frame 114a is detached from the front main frame 110 according to an embodiment of the present disclosure and a zipper formed at front left and right ends of the seat unit 300 is opened, a front upper end of the baby wagon 1 is opened to allow the caregiver to more intuitively view the baby in the baby wagon 1. When a front chair seat unit 320 is coupled to the open front upper end of the baby wagon 1, as shown in FIG. 21, a front exposed seat mode in which the baby can sit with their legs outstretched may be formed.

The front handle frame 115 is coupled to the left front and the right front of the front main support frame 114 in an upright state, and a handle structure is formed at an upper end of the front handle frame 115.

Referring to FIGS. 7-8, an axial rotation structure is formed at each of the left and right upper ends of the front handle frame 115 in a symmetrical fashion, and a rotation control button 115a-1 is formed at the outside of the axial rotation structure to adjust and fix the stepwise angle of a front angle adjustment handle 115a configured to interconnect the left and right upper ends of the front handle frame 115.

The stepwise angle of the front angle adjustment handle 115a is adjusted by button adjustment type rotation of the rotation control button 115a-1, and the angle of the front angle adjustment handle 115a may be set by selection of the caregiver in the state in which each of the left and right rotation control buttons 115a-1 is pushed.

The front angle adjustment handle 115a is rotatable through ten steps from an angle of 0 degrees, at which the front angle adjustment handle 115a is folded in a state of being parallel to the front main support frame 114, to an angle of 180 degrees, at which the front angle adjustment handle 115a is upright in the opposite direction.

The front angle adjustment handle 115a may be rotated stepwise to predetermined angles, and the angle of the front angle adjustment handle 115a may be changed depending on the height of the caregiver, and the position of the arms of the caregiver, an uphill road, a downhill road, movement of the baby wagon 1 by pulling of the front angle adjustment handle 115a in front of the front angle adjustment handle 115a, or movement of the baby wagon 1 by pushing of the front angle adjustment handle 115a, whereby force applied to the arms of the caregiver may be minimized. In the folding mode, the front angle adjustment handle 115a may be disposed parallel to the front main support frame 114, whereby the volume of the baby wagon 1 may be minimized.

Also, in the case in which the angle of the front angle adjustment handle 115a is set to an angle of 90 degrees, which becomes a right angle in the outward direction, when the baby wagon 1 is moved by pushing the front angle adjustment handle 115a, the distance between the feet of the caregiver and the baby wagon 1 is maximized, whereby it is possible to prevent a kickback phenomenon in which the foot of the caregiver, which steps forwards when the caregiver walks, collides with the baby wagon 1, thereby enabling the caregiver to walk comfortably and improving the ride comfort of the baby.

Second, the rear main frame 120 according to an embodiment of the present disclosure will be described.

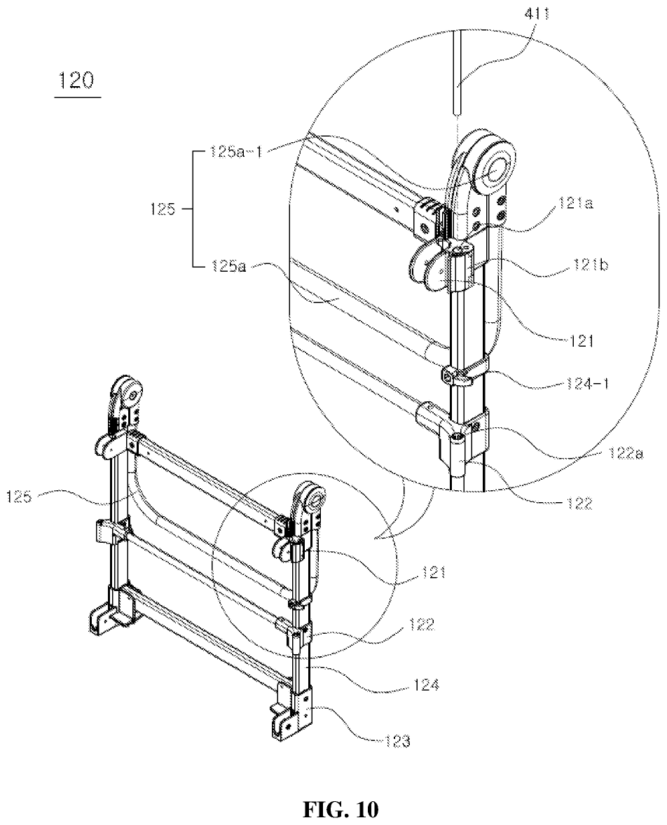

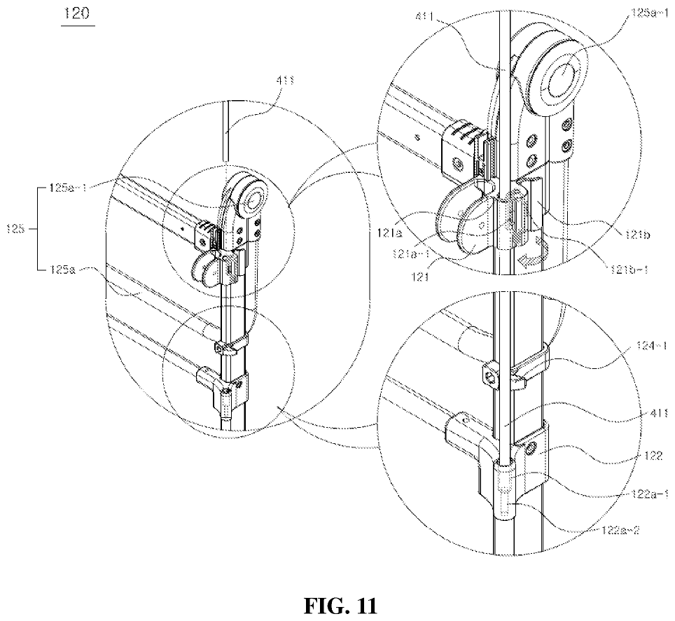

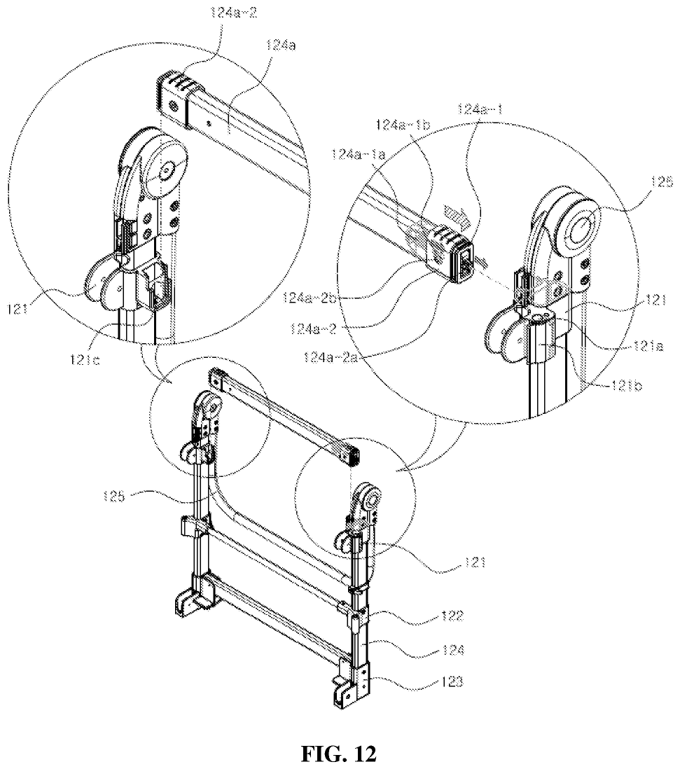

Referring to FIGS. 10-12, the rear main frame 120, which is a frame having a quadrangular structure disposed at the rear end of the foldable main body frame 100 in an upright state, supports the rear of the foldable main body frame 100.

The rear main frame 120 includes a rear upper end support fixture 121, a rear center support fixture 122, a rear lower end support fixture 123, a rear main support frame 124, and a rear handle frame 125.

The rear upper end support fixture 121 is formed at each of left and right sides of an upper end of the rear main frame 120 in a symmetrical fashion, and the front of the rear upper end support fixture 121 is coupled to an upper rear end of the side frame 130 through an axial structure to support the upper rear end of the side frame 130.

The rear upper end support fixture 121 according to an embodiment of the present disclosure is configured such that a pole through-hole 121a is formed through one side of an outer part thereof in the vertical direction, a rotation locking switch 121b is formed at one side of an outer surface thereof, and a switch protrusion 121b-1 of the rotation locking switch 121b is detached from and coupled to a switch fixing recess 121a-1 connected to the pole through-hole 121a, whereby a canopy fixing pole 411 inserted thereinto is fixed and separated.

The pole through-hole 121a is a hole that is formed perpendicularly through one side of an upper end surface of the rear upper end support fixture 121 in the outward direction, and is configured such that the switch fixing recess 121a-1 connected to the pole through-hole 121a is formed at one side thereof in the outward direction, whereby the switch protrusion 121b-1 located inside the rotation locking switch 121b is detached therefrom and coupled thereto, and the canopy fixing pole 411 is inserted thereinto in the vertical direction.

The rotation locking switch 121b is configured such that a rotation shaft is formed at one side of the rear upper end support fixture 121 in the vertical direction, a handle configured to be rotated about the rotation shaft is formed at one side of an outer surface thereof, and the switch protrusion 121b-1 is formed at one side of an inner surface of the handle so as to protrude in the inward direction.

When the rotation locking switch 121b is pushed so as to come into contact with the outer surface of the rear upper end support fixture 121, the switch protrusion 121b-1 is coupled to the switch fixing recess 121a-1, and the side surface of the canopy fixing pole 411 inserted into the pole through-hole 121a is supported, whereby the canopy fixing pole 411 is fixed. When the rotation locking switch 121b is pulled so as to be spaced apart from the outer surface of the rear upper end support fixture 121, the switch protrusion 121b-1 is detached from the switch fixing recess 121a-1 and is spaced apart from the canopy fixing pole 411 inserted into the pole through-hole 121a, whereby the canopy unit 400 is separated.

The canopy fixing pole 411 may be easily locked or unlocked, the height fixed position of the canopy unit 400 may be changed, and the canopy unit 400 may be easily detached and coupled by pushing or pulling the rotation locking switch 121b about the rotation shaft of the rotation locking switch 121b.

The rear center support fixture 122 is formed at each of left and right sides of the center of the rear main frame 120 in a symmetrical fashion, and a step through-hole 122a, which has a circular step, is formed at one side of an outer part thereof in the vertical direction.

The step through-hole 122a is a hole that is located at one side of the rear center support fixture 122 in the outward direction and is formed to be aligned with the pole through-hole 121a in the vertical direction. The step through-hole 122a is configured such that an upper end circular step 122a-1, into which a lower end of the canopy fixing pole 411 can be inserted so as to be supported thereby, is formed at an upper end of the step through-hole 122a and is configured such that a lower end through-hole 122a-2 is in a lower end of the center of the upper end circular step 122a-1.

The lower end of the canopy fixing pole 411 is inserted into and supported by the upper end circular step 122a-1 of the step through-hole 122a when the canopy fixing pole 411 is lowered to form the lower end sunshade mode.

If foreign matter is introduced into the upper end circular step 122a-1, the foreign matter may be easily discharged through the lower end through-hole 122a-2 of the step through-hole 122a, thereby facilitating cleaning management and ensuring that the canopy fixing pole 411 can be stably seated.

The rear lower end support fixture 123 is formed at each of left and right sides of the lower end of the rear main frame 120 in a symmetrical fashion. The front of the rear lower end support fixture is coupled to a lower rear end of the side frame 130 through an axial structure so as to be supported thereby. A rear wheel unit (rear wheel assembly) 220 is coupled vertically upward to one side of the lower end of the rear lower end support fixture 123, whereby the rear wheel unit (rear wheel assembly) 220 is supported thereby.

The rear main support frame 124, which is a frame coupled to the rear upper end support fixture 121 and the rear lower end support fixture 123, which are formed in left-right symmetry, so as to have a quadrangular shape, serves to support the entirety of the rear main frame 120.

A folding locking protrusion 124-1 is formed at one side of each of left and right side surfaces of the rear main support frame 124 in a symmetrical fashion.

The folding locking protrusion 124-1 is located so as to be inserted into and coupled to a protrusion insertion recess 133b-1a of a folding locking bar 133b-1 protruding backward in the outward direction as the lower end central axis support fixture 133b of the side frame 130 is moved upward when the mode of the foldable main body frame 100 is switched to the folding mode.

When the mode of the foldable main body frame 100 is switched to the folding mode, therefore, the folding locking protrusion 124-1 is inserted into and fixed to the protrusion insertion recess 133b-1a located at the folding locking bar of the side frame 130, thereby preventing the foldable main body frame 100 from being unfolded unintentionally by the user, and therefore it is possible to stably store or move storage or movement of the baby wagon 1 in the folding mode and to minimize the volume of the baby wagon 1.

In addition, the main support frame 124 according to the present disclosure is provided at an upper end thereof with a rear upper end horizontal frame 124a, which is supported in a horizontal state.

The rear upper end horizontal frame 124a is a frame coupled to left and right inner surfaces of the rear upper end support fixture 121 so as to support the rear upper end support fixture 121 in a horizontal state, is coupled to and separated from the rear upper end support fixture 121 through a sliding structure, and is configured to be switched to a rear exposed seat mode, and is provided with an inner fixed frame 124a-1 and a slide frame 124a-2.

The inner fixed frame 124a-1 is a frame inserted into and fixed to left and right ends of the rear upper end horizontal frame 124a, a spring 124a-1a is laid down in the inner fixed frame 124a-1 in the leftward-rightward direction in the state in which one side of the spring is fixed and the other side of the spring 124a-1a is in contact with the slide frame 124a-2 so as to have elasticity, and a long hole 124a-1b, which is a long hole formed in the leftward-rightward direction, is formed so as to receive a side protrusion 124a-2b moved according to the leftward-rightward movement of the slide frame 124a-2.

The slide frame 124a-2 is a frame formed on peripheries of the left and right sides of the rear upper end horizontal frame 124a, wherein one side of the interior of the slide frame 124a-2 is inserted into the inner fixed frame 124a-1, and is configured such that an insertion protrusion 124a-2a engaged with an inner recess 121c of the rear upper end support fixture 121 so as to be detached therefrom and be coupled thereto is formed at each of the left and right ends thereof and such that the side protrusion 124a-2b protrudes from each of the front and rear sides thereof through the long hole 124a-1b.

When each of the slide frames 124a-2 formed at the left and right sides is pulled inward, the side protrusion 124a-2b moves inward along the long hole 124a-1b, whereby the spring 124a-1a is compressed, and the insertion protrusion 124a-2a moves inward and is separated from the inner recess 121c of the rear upper end support fixture 121, whereby the rear upper end horizontal frame 124a is detached therefrom. In order to couple the rear upper end horizontal frame 124a, each of the slide frames 124a-2 formed at the left and right sides is pulled inward, the position of the slide frame 124a-2 is fixed at the inside of the rear upper end support fixture 121, and the slide frame 124a-2 is released, whereby the insertion protrusion 124a-2a is inserted into the inner recess 121c of the rear upper end support fixture 121, and therefore it is possible to couple the rear upper end horizontal frame 124a.

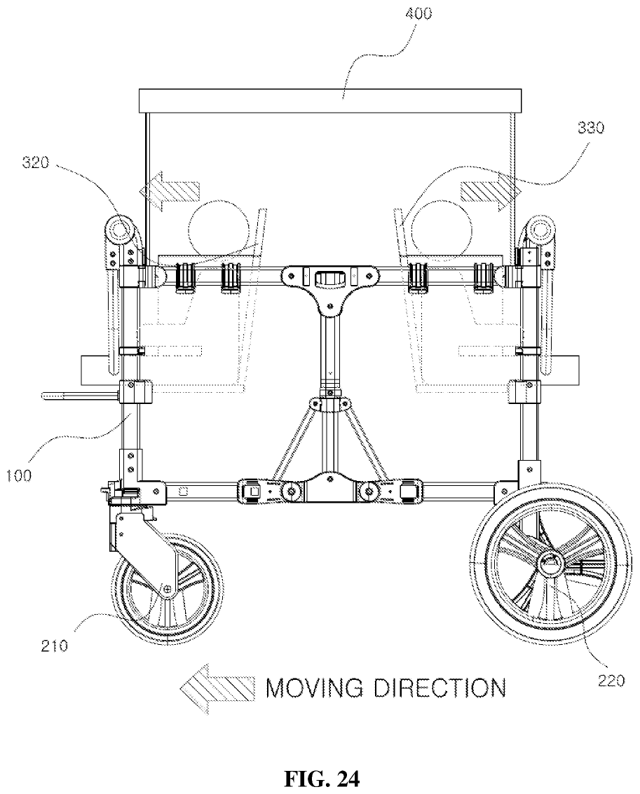

When the rear upper end horizontal frame 124a is detached from the rear main frame 120 according to an embodiment of the present disclosure and a zipper formed at rear left and right ends of the seat unit (seat assembly) 300 is opened, a rear upper end of the baby wagon 1 is opened to allow the caregiver to more intuitively view the baby in the baby wagon 1. When a rear chair seat unit (rear chair assembly) 330 is coupled to the open rear upper end of the baby wagon 1, as shown in FIG. 24, a rear exposed seat mode in which the baby can sit with their legs outstretched may be formed.

The rear handle frame 125 is coupled to the left rear and the right rear of the rear main support frame 124 in an upright state, and a handle structure is formed at an upper end of the rear handle frame 125.

An axial rotation structure is formed at each of the left and right upper ends of the rear handle frame 125 in a symmetrical fashion, and a rotation control button 125a-1 is formed at the outside of the axial rotation structure to adjust and fix the stepwise angle of a rear angle adjustment handle 125a configured to interconnect the left and right upper ends of the rear handle frame 125.

The stepwise angle of the rear angle adjustment handle 125a is adjusted by button adjustment type rotation of the rotation control button 125a-1, and the angle of the rear angle adjustment handle 125a may be set by selection of the caregiver in the state in which each of the left and right rotation control buttons 125a-1 is pushed.

The rear angle adjustment handle 125a is rotatable through ten steps from an angle of 0 degrees, at which the rear angle adjustment handle 125a is folded in a state of being parallel to the main support frame, to an angle of 180 degrees, at which the rear angle adjustment handle 125a is upright in the opposite direction.

The rear angle adjustment handle 125a may be rotated stepwise to predetermined angles, and the angle of the rear angle adjustment handle 125a may be changed depending on the height of the caregiver, and the position of the arms of the caregiver, an uphill road, a downhill road, movement of the baby wagon by pulling of the rear angle adjustment handle 125a in front of the rear angle adjustment handle 125a, or movement of the baby wagon 1 by pushing of the rear angle adjustment handle 125a, whereby force applied to the arms of the caregiver may be minimized. In the folding mode, the rear angle adjustment handle 125a may be disposed parallel to the rear main support frame 124, whereby the volume of the baby wagon 1 may be minimized.

Also, in the case in which the angle of the rear angle adjustment handle 125a is set to an angle of 90 degrees, which becomes a right angle in the outward direction, when the baby wagon 1 is moved by pushing the rear angle adjustment handle 125a, the distance between the feet of the caregiver and the baby wagon 1 is maximized, whereby it is possible to prevent a kickback phenomenon in which the foot of the caregiver, which steps forwards when the caregiver walks, collides with the baby wagon 1, thereby enabling the caregiver to walk comfortably and improving the ride comfort of the baby.

Third, the side frame 130 according to an embodiment of the present disclosure will be described.

FIG. 6 is an exploded perspective view showing components of the main body frame according to an embodiment of the present disclosure.

The side frame 130 is coupled to the front main frame 110 and the rear main frame 120 through a symmetrical axial rotation structure therebetween so as to be supported thereby, and is folded while being rotated about the axis.

The side frame 130 includes a side upper end frame 131, a side lower end frame 132, and a vertical connection frame 133.

The side upper end frame 131, which is a frame having a front-rear symmetry axial rotation structure constituting the upper end of the side frame 130, is axially coupled to the upper end of the front main frame 110 and the upper end of the rear main frame 120 therebetween so as to be rotated and fixed in a symmetrical fashion based on the vertical connection frame located at the center thereof.

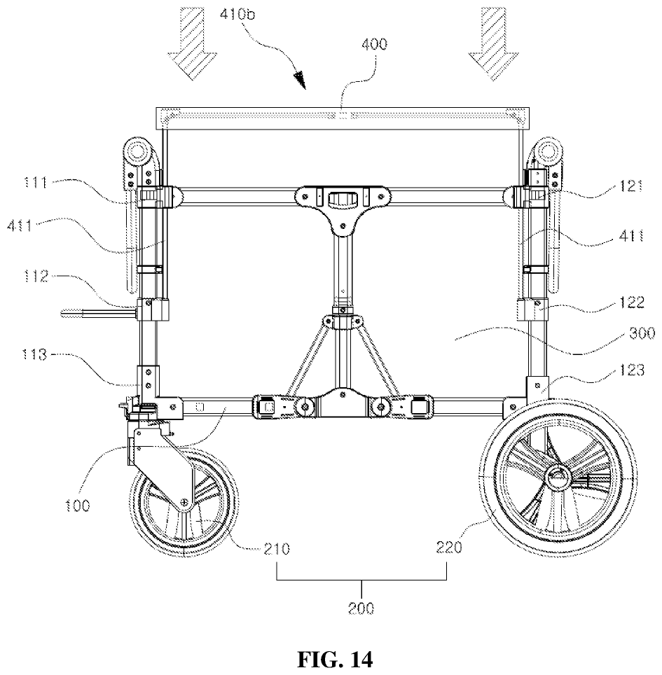

Referring to FIG. 14, FIG. 14 is a side view showing the state in which the canopy fixing pole of the wagon canopy unit according to an embodiment of the present invention disclosure extends through the front upper end support fixture and the rear upper end support fixture and is coupled to the front center support fixture and the rear center support fixture, whereby the wagon canopy unit is fixed as low as the height of the front center support fixture and the rear center support fixture from the front upper end support fixture and the rear upper end support fixture.

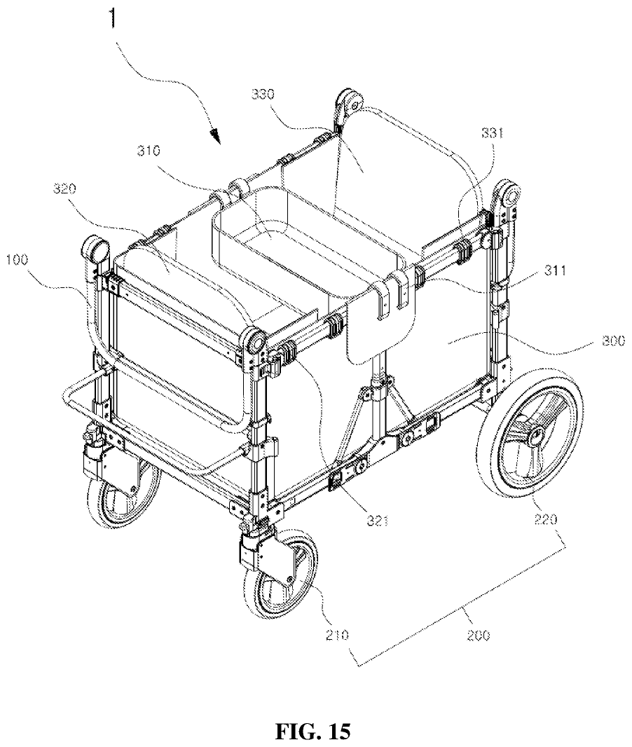

The front and rear frames are fixed in a state of being horizontally disposed in a baby wagon 1 usage mode, and the front and rear frames are fixed in an inclined state in a baby wagon 1 folding mode. Referring to FIGS. 6 and 15, a tray unit (tray assembly) 310, a front chair seat unit (front chair seat assembly) 320, and a rear chair seat unit (rear chair seat assembly) 330 are detachably coupled to the side upper end frame 131 according to an embodiment of the present disclosure.

The tray unit 310, which has a quadrangular tray shape, is provided at left and right outer surfaces thereof with fixing clips 311, which are formed so as to extend vertically downward in a symmetrical fashion and by which the tray unit is detachably coupled to the side upper end frame having the left-right symmetry structure.

The front chair seat unit 320, which has a backrest chair seat shape, is provided at left and right outer surfaces thereof with fixing clips 321, which are formed so as to extend vertically downward in a symmetrical fashion and by which the front chair seat unit is detachably coupled to the front of the side upper end frame 131 having the left-right symmetry structure.

The front chair seat unit 320 according to an embodiment of the present disclosure is provided at one side of the center thereof in the vertical direction with an angle adjustment belt 323 formed along peripheries of a left surface, a backrest surface, and a right surface thereof, and a backrest angle adjustment portion 322 is formed at the center of the rear of the backrest surface.

The rear chair seat unit 330, which has a backrest chair seat shape, is provided at left and right outer surfaces thereof with fixing clips 331, which are formed so as to extend vertically downward in a symmetrical fashion and by which the rear chair seat unit 330 is detachably coupled to the rear of the side upper end frame 131 having the left-right symmetry structure.

The rear chair seat unit 330 according to an embodiment of the present disclosure is provided at one side of the center thereof in the vertical direction with an angle adjustment belt 333 formed along peripheries of a left surface, a backrest surface, and a right surface thereof, and a backrest angle adjustment portion 332 is formed at the center of the rear of the backrest surface.

Referring to FIG. 6, the side lower end frame 132, which is a frame having a front-rear symmetry axial rotation structure constituting the lower end of the side frame 130, is axially coupled to the lower end of the front main frame 110 and the lower end of the rear main frame therebetween so as to be rotated and fixed in a symmetrical fashion based on the vertical connection frame located at the center thereof.

The front and rear frames are fixed in a state of being horizontally disposed in the baby wagon usage mode, and the front and rear frames are fixed in an inclined state in the baby wagon folding mode.

Referring to FIG. 6, the vertical connection frame 133 is a frame that is connected to the center of the side upper end frame 131 and the center of the side lower end frame 132 through an axial rotation structure while being disposed in the vertical direction, and supports the axial rotation of the side upper end frame 131 and the side lower end frame 132 in a front-rear symmetry structure.

The vertical connection frame 133 includes an upper end central axis support fixture 133a, a lower end central axis support fixture 133b, a side main frame 133c, and a fixing frame 133d.

The upper end central axis support fixture 133a is formed at an upper end of the vertical connection frame 133 and is connected to the side upper end frame 131 at the front and rear thereof trough an axial rotation structure, and a folding handle 133a-1 configured to slidably move in an upward-downward direction is formed at an outer surface of the upper end central axis support fixture 133a.

Here, when the left and right folding handles 133a-1 are pulled in the upward direction, a fixed state of an auxiliary frame 134 is released such that the side frame 130 can be folded in the upward direction, whereby it is possible to switch the mode of the foldable main body frame 100 to the folding mode. When the folding handles 133a-1 are pulled in the upward direction to release the fixed state and are then put down, the side upper end frame 131 and the side lower end frame 132 may be unfolded horizontally, whereby it is possible to switch the mode of the foldable main body frame 100 to the usage mode.

This allows the mode of the foldable main body frame 100 to be switched to a folding mode that requires the caregiver to simultaneously pull a pair of folding handles with both hands, preventing the caregiver's hands from getting caught in the space between the frames that rotate in the axial structure when switching between the folding mode and the usage mode of the baby wagon 1 is performed, and enabling the baby wagon's shape to be varied reliably.

The lower end central axis support fixture 133b is formed at a lower end of the vertical connection frame 133 and is connected to the side lower end frame 132 at the front and rear thereof trough an axial rotation structure,

The lower end central axis support fixture 133b is provided with a folding locking bar 133b-1.

The folding locking bar 133b-1 is a bar protruding from an outer surface of the lower end central axis support fixture 133b in left-right symmetry, and a protrusion insertion recess 133b-1a is formed in one side of an inner surface of the protruding bar.

The upper end central axis support fixture 133a is coupled to an upper end of the side main frame 133c, and the lower end central axis support fixture 133b is coupled to a lower end of the side main frame 133c. The side main frame 133c is upright to support the entirety of the vertical connection frame.

The fixing frame 133d is coupled and fixed to the periphery of one side of the center of the side main frame 130 in a height direction while having a quadrangular structure.

The auxiliary frame 134 according to an embodiment of the present disclosure is configured such that a moving frame 134a having a through-hole formed in the center thereof is inserted through the side main frame 130 and is moved upward and downward along the side main frame 130 and such that an auxiliary link frame 134b having a front-rear symmetric hinge structure is coupled to the side lower end frame 132.

In the baby wagon usage mode, therefore, the auxiliary frame 134 prevents rotation of the side lower end frame 132 in the link structure and disperses load intensively applied downward to the center of the side lower end frame 132 in the forward-rearward direction, whereby stability and durability of the baby wagon 1 are guaranteed while allowable boarding load is increased. In the baby wagon folding mode, the auxiliary frame 134 auxiliary supports rotation of the side lower end frame 132 in the link structure and prevents breakage of or damage to the link-structure frame during carrying and storage of the baby wagon 1.

In addition, the auxiliary frame 134 allows the side lower end frames 132, which are located in the front of the vertical connection frame 133 and at the rear of the vertical connection frame 133, to be rotated at the same rotational speed when switching between the usage mode and the folding mode of the baby wagon 1 is performed.

As a result, the front and rear side upper end frames 131 and 132 are prevented from being asymmetrically rotated through the link structure when switching between the modes of the baby wagon 1 is performed, whereby stability of the baby wagon 1 may be guaranteed when the baby wagon 1 is folded or unfolded, and primary rotation of the side upper end frame 131 and the side lower end frame 132 through link structure and secondary rotation of the auxiliary frame 134 through the link structure are simultaneously performed, whereby the shape of the baby wagon 1 may be smoothly changed.

Next, the wagon wheel unit (wagon wheel assembly) 200 according to an embodiment of the present disclosure will be described.

The wagon wheel unit (wagon wheel assembly) 200 is fastened to the front lower end and the rear lower end of the foldable main body frame 100 in order to move the baby wagon.

The wagon wheel unit (wagon wheel assembly) 200 includes at least one front wheel unit (front wheel assembly) 210 and at least one rear wheel unit (rear wheel assembly) 220.

The front wheel unit 210, which is configured such that wheels are coupled to left and right lower ends of the front main frame 110 so as to contact the ground, supports the front lower end of the baby wagon 1, is rotated under control of the caregiver, and serves to move and stop the baby wagon 1.

The rear wheel unit 220, which is configured such that wheels are coupled to left and right lower ends of the rear main frame 120 in a symmetrical fashion so as to contact the ground, supports the rear lower end of the baby wagon 1, and serves to move and stop the baby wagon 1 while being rotated under control of the caregiver.

Next, the seat unit 300 according to an embodiment of the present disclosure will be described.

The seat unit 300 is formed in the shape of a rectangular basket. The seat unit 300 is coupled and fixed to the inner circumference and the lower end of the foldable main body frame 100 using any one of snap fasteners, buckles, and Velcro members. The seat unit 300 serves to provide a space in which the baby can comfortably rest in the baby wagon 1.

A five-point coupling type safety belt is formed at each of the front chair seat unit 320, the rear chair seat unit 330, and the front and the rear of the inside of the seat unit 300 according to an embodiment of the present disclosure so as to face each other, whereby the shoulders, the waist, and the thighs of the baby are supported so as not to shake.

The five-point coupling type safety belt surrounds the entirety of the upper body. Consequently, babies and children of various ages, including babies who cannot keep themselves steady and children, can ride in the baby wagon.

The tray unit 310, the front chair seat unit 320, and the rear chair seat unit 330 are detachably coupled to the seat unit 300 according to an embodiment of the present disclosure.

The tray unit 310, which has a quadrangular tray shape, is provided at left and right outer surfaces thereof with fixing clips 311, which are formed so as to extend vertically downward in a symmetrical fashion and by which the tray unit 310 is detachably coupled to the side upper end frame having the left-right symmetry structure.

The tray unit 310 allows toys, food, beverage, a smart device, etc. to be placed thereon or to be received therein.

Consequently, it is possible to place toys, snacks, beverage, etc. for the baby in the baby wagon 1 on the tray unit 310 or to hold a smart device to the tray unit 310 such that the baby in the baby wagon 1 can watch video.

Here, each fixing clip 311 is detachably coupled to the upper end of the side frame 130 in a left-right symmetrical fitting manner.

Consequently, the caregiver may remove and couple the tray unit 310 having the fitting structure from and to the side upper end frame 131, whereby it is possible to selectively use the tray unit 310 depending on the usage situation, such as eating of the baby or placing the smart device and the toys on the tray unit 310.

The front chair seat unit 320 has a backrest chair seat shape formed at the inner front of the seat unit 300, and fixing clips 321 are formed on left and right outer surfaces of the front chair seat unit 320 in a symmetrical vertical downward direction so as to be detached from and coupled to the side upper end frame in left-right symmetry.

A five-point safety belt is coupled to the front chair seat unit 320 according to an embodiment of the present disclosure.

This makes it possible to secure the baby in the baby wagon 1, whereby, when sudden external impact is applied to the baby wagon 1 or when the baby wagon 1 is moved over uneven ground, their body may be stably supported and the impact may be relieved.

Consequently, it is possible for the front chair seat unit 320 to secure the baby in a stable and comfortable position through the five-point safety belt such that the baby seated in the chair seat unit 300 can maintain a stable position even when the baby wagon 1 is shaken or external impact is applied to the baby wagon 1 and to improve ride comfort.

The rear chair seat unit 330 has a backrest chair seat shape formed at the inner rear of the seat unit 300, and fixing clips 331 are formed on left and right outer surfaces of the rear chair seat unit 330 in a symmetrical vertical downward direction so as to be detached from and coupled to the side upper end frame in left-right symmetry.

A five-point safety belt is coupled to the rear chair seat unit 330 according to an embodiment of the present disclosure.

This makes it possible to secure the baby in the baby wagon 1, whereby, when sudden external impact is applied to the baby wagon or when the baby wagon 1 is moved over uneven ground, their body may be stably supported and the impact may be relieved.

Consequently, it is possible for the rear chair seat unit 330 to secure the baby in a stable and comfortable position through the five-point safety belt such that the baby seated in the chair seat unit 300 can maintain a stable position even when the baby wagon is shaken or external impact is applied to the baby wagon and to improve ride comfort.

The seat unit 300 according to an embodiment of the present disclosure has the following features.

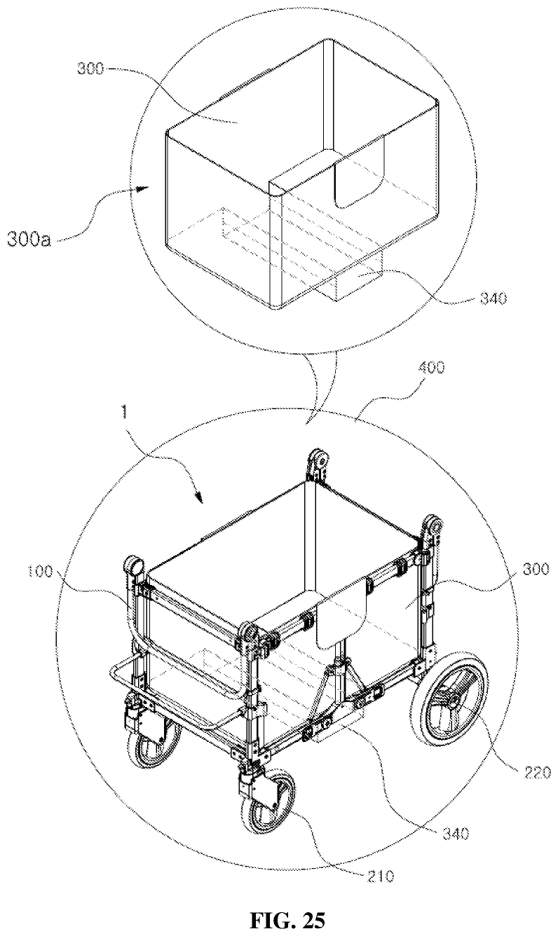

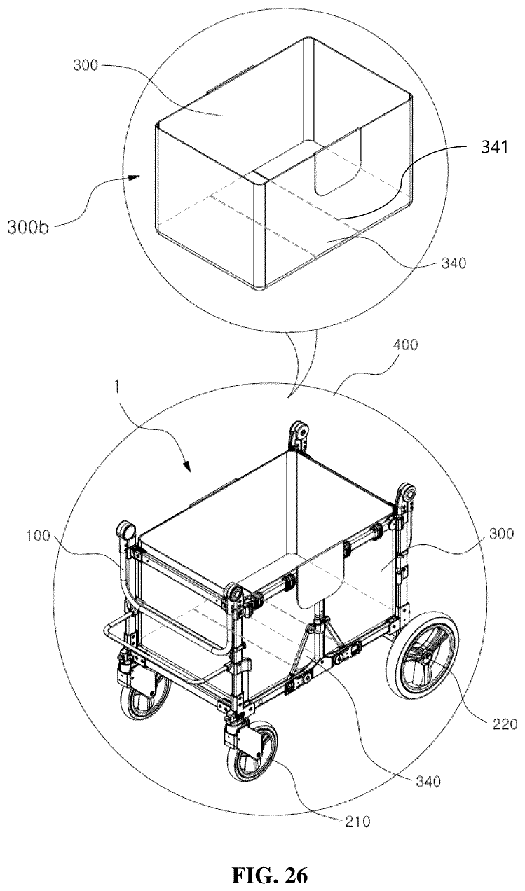

First, the mode of the seat unit 300 according to an embodiment of the present disclosure may be selectively switched to any one of a standing seat mode 300a (FIG. 25) and a sitting seat mode 300b (FIG. 26) depending on whether a footrest pocket formed at a lower surface of the seat unit 300 is opened or closed.

In the standing seat mode 300a, zippers formed at the front and the rear of one side of the center of the lower surface of the seat unit in the leftward-rightward direction are opened, whereby a quadrangular footrest pocket (quadrangular footrest assembly) 340 formed in the downward direction is unfolded to form a standing chair.

That is, when the zippers formed at the front and the rear of one side of the center of the lower surface of the seat unit 300 so as to be parallel to each other in the leftward-rightward direction are opened, the quadrangular footrest pocket 340 in the center of the seat unit 300 that has been folded and fixed by the zippers is unfolded in the downward direction, forming a space in which the legs of the baby in the seat unit 300 can be lowered to the inside of the quadrangular footrest pocket 340 such that the baby can sit in a standing state.

In the sitting seat mode 300a (FIG. 25), the zippers formed in the leftward-rightward direction are closed in the state in which the quadrangular footrest pocket 340 unfolded downward at the front and the rear of one side of the center of the lower surface of the seat unit 300 is folded to form a sitting chair.

That is, when the quadrangular footrest pocket 340 unfolded downward at the center of the lower surface of the seat unit 300 is folded in the upward direction and the zippers formed in parallel to each other at the front and the rear of the seat unit 300 in the leftward-rightward direction are closed to flatten the lower surface of the seat unit 300, the baby may sit in a sitting position, such as sitting cross-legged or sitting stretched out.

In this way, the mode of the seat unit 300 may be selectively switched to one of the standing seat mode 300a (FIG. 25) and the sitting seat mode 300b (FIG. 26) such that the riding posture of the baby can be easily varied according to the needs of the baby, thereby improving the satisfaction of use in the baby wagon 1, and the baby may be seated in a comfortable posture depending on the situation, thereby improving ride comfort.

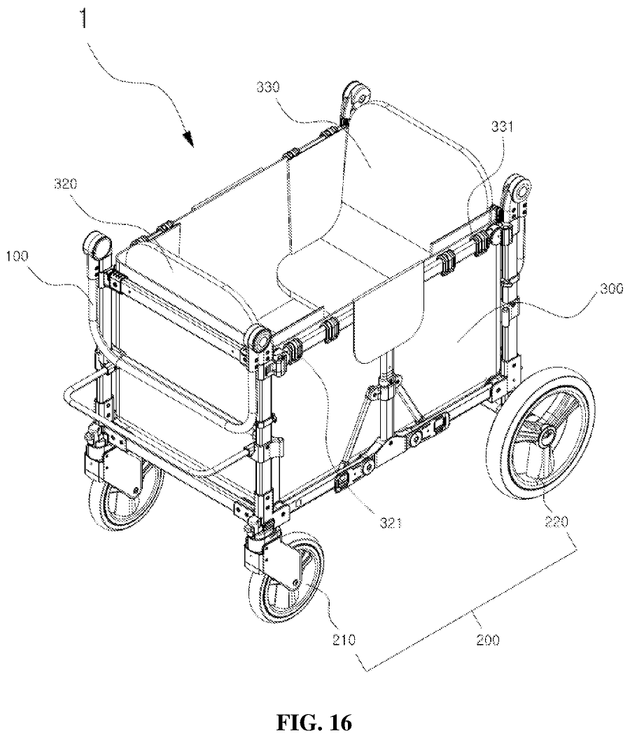

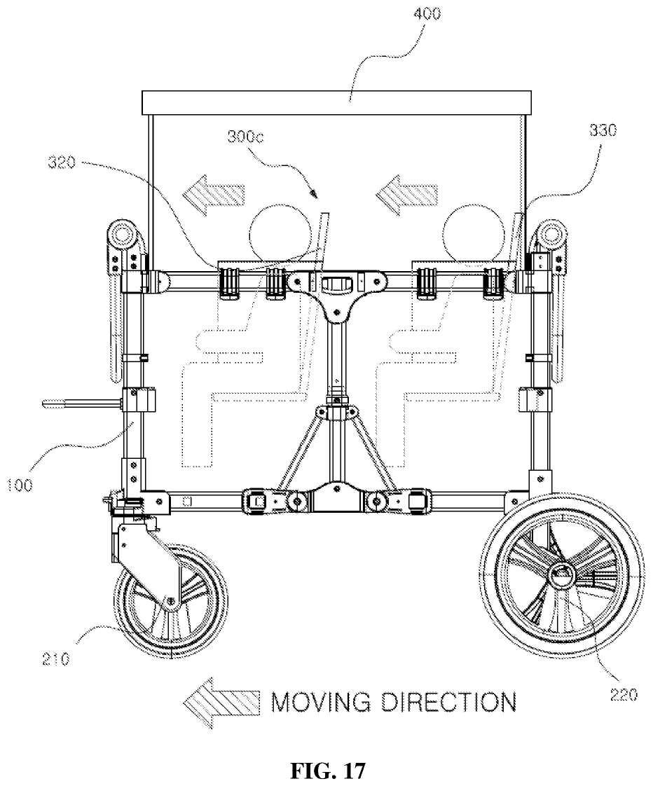

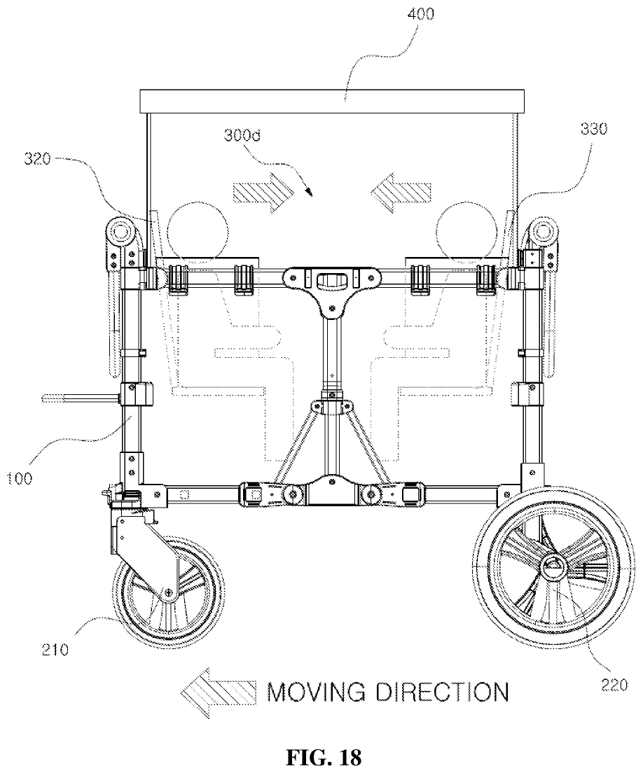

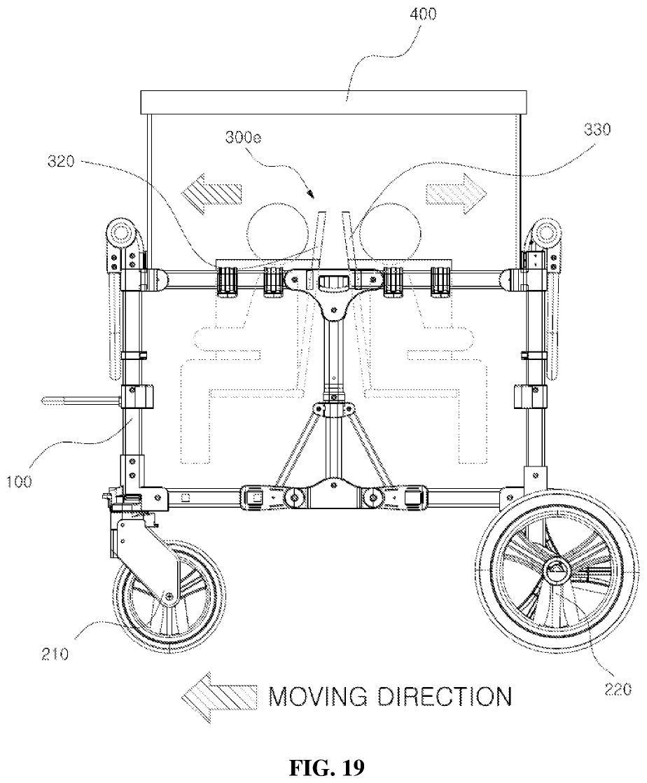

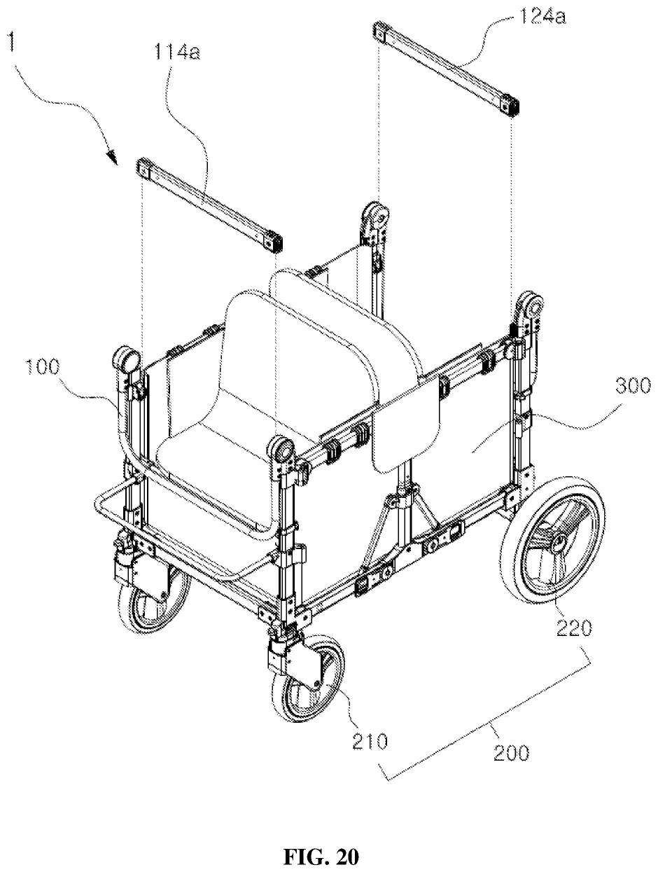

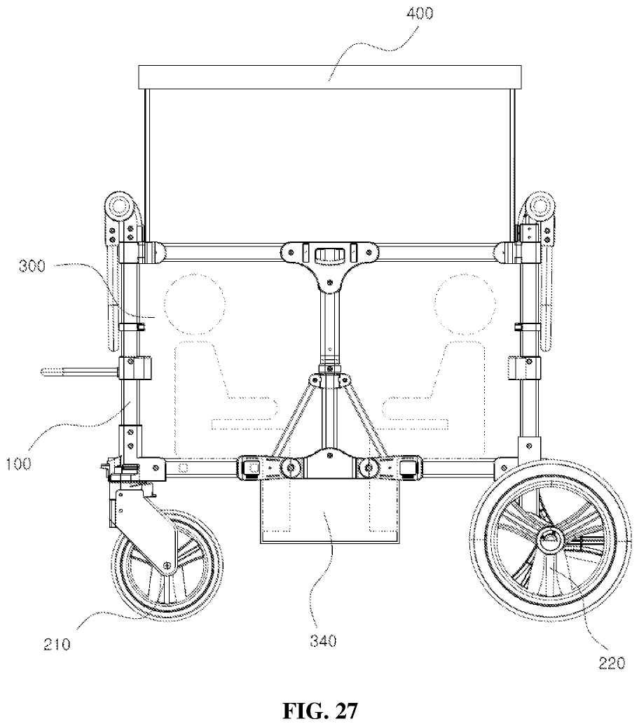

Second, the seat unit 300 according to an embodiment of the present disclosure may be selectively operated in any one of a dual front seat mode 300c (FIG. 17), a dual inner seat mode 300d (FIGS. 16, 18, and 27), and a dual outer seat mode 300e (FIGS. 19-21) depending on the coupling direction of the front chair seat unit 320 and the rear chair seat unit 330.

In the dual front seat mode 300c (FIG. 17), the front chair seat unit 320 is located so as to face in a front direction and is fixed to one side of the center of the interior of the foldable main body frame 100 by coupling between the left and right fixing clips 321, and the rear chair seat unit 330 is located so as to face in the front direction and is fixed to one side of the rear of the interior of the foldable main body frame 100 by coupling between the left and right fixing clips 331.

In the dual inner seat mode 300d (FIGS. 16, 18, and 27), the front chair seat unit 320 is located so as to face in a rear direction and is fixed to one side of the front of the interior of the foldable main body frame 100 by coupling between the left and right fixing clips 321, and the rear chair seat unit 330 is located so as to face in the front direction and is fixed to one side of the rear of the interior of the foldable main body frame 100 by coupling between the left and right fixing clips 331.

In the dual outer seat mode 300e (FIGS. 19-21), the front chair seat unit 320 is located so as to face in the front direction and is fixed to one side of the center of the interior of the foldable main body frame 100 by coupling between the left and right fixing clips 321, and the rear chair seat unit 330 is located so as to face in the rear direction and is fixed to one side of the center of the interior of the foldable main body frame 100 such that the backrest of the rear chair seat unit 330 faces the backrest of the front chair seat unit by coupling between the left and right fixing clips 331.

Since the seat unit 300 is selectively operated in any one of the dual front seat mode 300c, the dual inner seat mode 300d, and the dual outer seat mode 300e, as described above, the riding direction may be varied according to the needs of the baby, thereby improving the satisfaction of use when riding, and the baby may be seated in a comfortable posture according to the situation, thereby improving ride comfort.

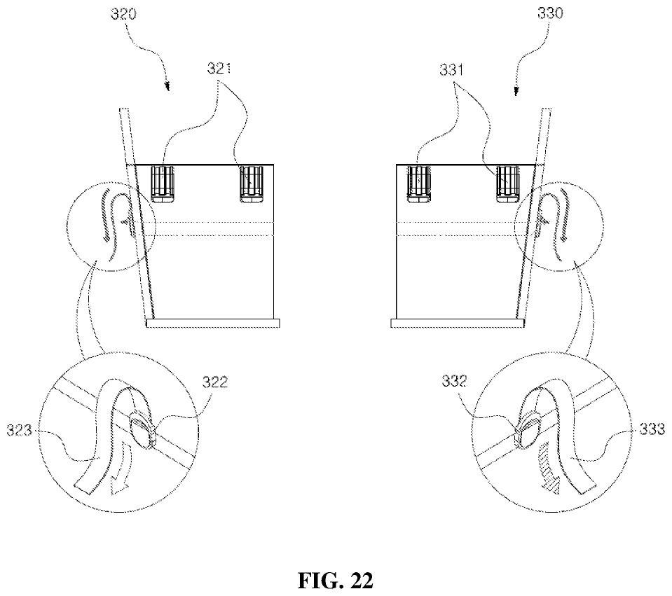

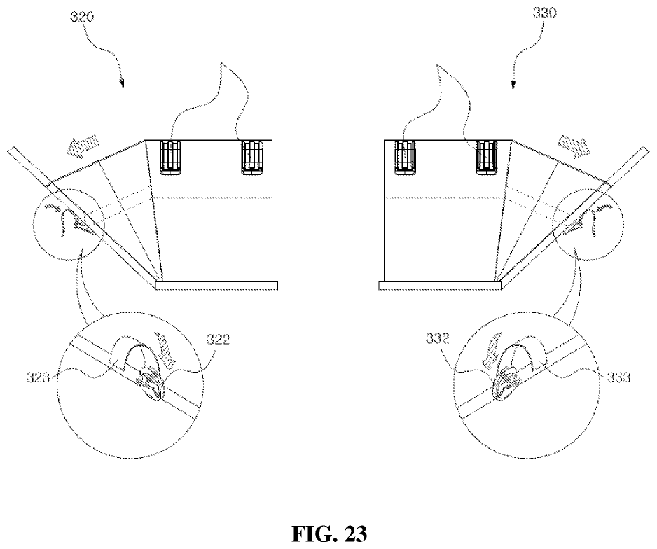

Third, the front chair seat unit 320, which is a component of the seat unit 300 according to an embodiment of the present disclosure, is configured such that zippers are formed at the boundaries between the left and right surfaces and the backrest so as to be opened and closed in the longitudinal direction, the zippers are primarily opened, the angle adjustment belt 323 (FIGS. 22-23) is formed at the centers of the left and right surfaces along the peripheral surfaces thereof so as to extend to the center of the backrest at the rear such that the angle adjustment belt 323 extends through the backrest angle adjustment portion 322, and the angle adjustment belt 323 is secondarily pulled and released in the state in which the switch of the backrest angle adjustment portion 322 is open, whereby the angle of the backrest is adjusted.

Here, when the zippers formed at the boundaries between the backrest and the left and right surfaces of the front chair seat unit 320 in the longitudinal direction are opened, the switch of the backrest angle adjustment portion 322 may be pushed to pull and release the angle adjustment belt 323, whereby the angle of the backrest may be adjusted. When the zippers formed at the boundaries between the backrest and the left and right surfaces of the front chair seat unit 320 are closed, the backrest may be fixed, whereby the front chair seat unit 320 may be easily maintained in a structurally more stable state.

Thus, the backrest angle of the front chair seat unit 320 may be changed such that the baby can be seated in a comfortable position depending on the situation, thereby improving ride comfort.

In addition, the rear chair seat unit 330, which is a component of the seat unit 300 according to an embodiment of the present disclosure, is configured such that zippers are formed at the boundaries between the left and right surfaces and the backrest so as to be opened and closed in the longitudinal direction, the zippers are primarily opened, the angle adjustment belt 333 is formed at the centers of the left and right surfaces along the peripheral surfaces thereof so as to extend to the center of the backrest at the rear such that the angle adjustment belt 333 extends through the backrest angle adjustment portion 332, and the angle adjustment belt 333 is secondarily pulled and released in the state in which the switch of the backrest angle adjustment portion 332 is open, whereby the angle of the backrest is adjusted.

Here, when the zippers formed at the boundaries between the backrest and the left and right surfaces of the rear chair seat unit 330 in the longitudinal direction are opened, the switch of the backrest angle adjustment portion 322 may be pushed to pull and release the angle adjustment belt 323, whereby the angle of the backrest may be adjusted. When the zippers formed at the boundaries between the backrest and the left and right surfaces of the rear chair seat unit 330 are closed, the backrest may be fixed, whereby the rear chair seat unit 330 may be easily maintained in a structurally more stable state.

Thus, the backrest angle of the rear chair seat unit 330 may be changed such that the baby can be seated in a comfortable position depending on the situation, thereby improving ride comfort.

Next, the canopy unit 400 according to an embodiment of the present disclosure will be described.

The canopy unit 400 is detachably coupled to the upper end of the foldable main body frame 100, and serves to protect the baby from an external environment, such as sunlight, rain, or wind.

The canopy unit 400 includes at least one of a wagon canopy unit 410 and a baby carrier canopy unit 420.

The wagon canopy unit 410 is provided with a roof having a rectangular side surface, and four canopy fixing poles 411 forming a rectangular structure at a lower end of the roof are formed so as to be detachably coupled to the upper end of the foldable main body frame 100.

Here, each canopy fixing pole 411 is a round-bar-shaped pole disposed in an upright state. The canopy fixing pole 411 is vertically inserted into one side of the upper end of each of the left and right front upper end support fixtures 111 of the front main frame 110, and is vertically inserted into one side of the upper end of each of the left and right rear upper end support fixtures 121 of the rear main frame 120. The canopy fixing poles 411 are arranged so as to have a quadrangular structure.

The canopy unit 400 according to an embodiment of the present disclosure may be operated in any one of an upper end canopy mode 410a and a lower end sunshade mode 410b.

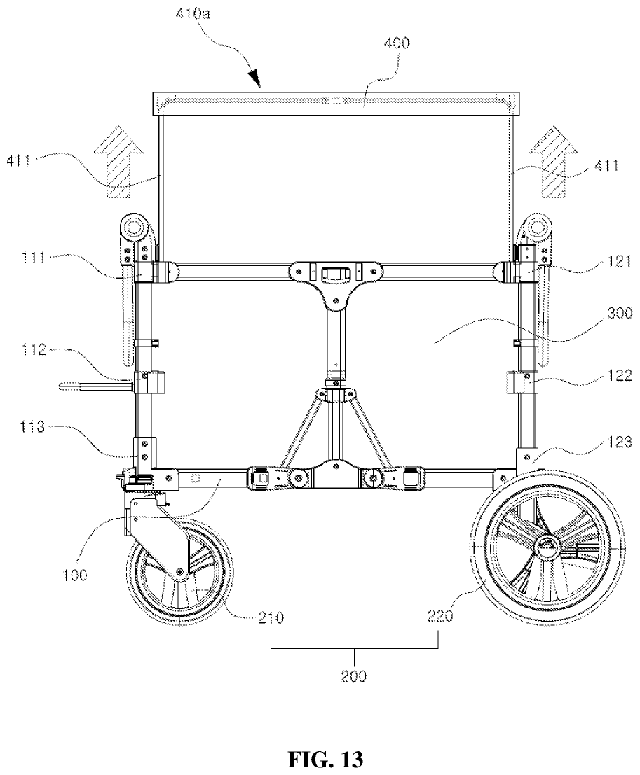

In the upper end canopy mode 410a (FIG. 13), the canopy fixing poles 411 are inserted into and coupled to upper end coupling portions of the front main frame 110 formed in left-right symmetry.

In the lower end sunshade mode 410b (FIG. 14), the canopy fixing poles 411 are inserted through the upper end coupling portions of the front main frame 110 formed in left-right symmetry and are inserted into and coupled to lower end coupling portions of the front main frame 110.

The wagon canopy unit 410 according to an embodiment of the present disclosure covers the entirety of the upper end of the foldable main body frame 100.

As a result, it is possible to protect the baby in the baby wagon 1 from an external environment, such as sunlight, rain, or wind, while providing comfort to the baby.

The baby carrier canopy unit 420 is configured such that baby carrier canopy roofs are detachably coupled to the front and the rear of the upper end of the foldable main body frame 100 in a symmetrical fashion in the inward direction.

The baby carrier canopy unit 420 according to an embodiment of the present disclosure may be individually detachably coupled to the front and the rear of the upper end of the foldable main body frame 100, and the baby carrier canopy unit 420 may be folded in a state of not being detached or may be used in an unfolded state as needed.

As a result, the field of vision of the baby in the baby wagon 1 may be broadened, the caregiver and the baby may respond to each other while looking at each other, and the behavior of the baby may be checked with the naked eye, whereby the caregiver may have a sense of security.

Hereinafter, the operation of the baby wagon 1 having improved convenience of use according to an embodiment of the present disclosure will be described in detail.

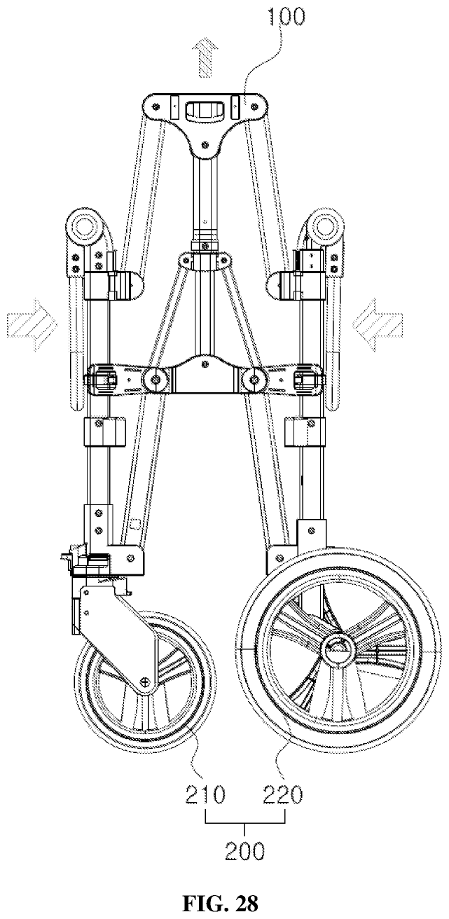

First, the left and right folding handles of the upwardly erected side frame of the baby wagon 1 in the folding mode, in which the baby wagon 1 is stored, are pulled upwards in order to release the locked state of the baby wagon, whereby the side upper end frame 131 and the side lower end frame 132 are horizontally unfolded as shown in FIGS. 6 and 28.

Subsequently, in consideration of the age, physical growth, and activity of the baby and depending on the needs of the baby, the zippers formed at the front and the rear of one side of the center of the bottom surface of the seat unit 300 so as to extend in the leftward-rightward direction are opened to form a standing seat mode, or the zippers are closed to form a sitting seat mode.

For two or more babies, the sitting seat mode may be selected, and then the mode of the front chair seat unit 320 and the rear chair seat unit 330 may be selectively switched to any one of the dual front seat mode, the dual inner seat mode, and the dual outer seat mode according to the needs of the babies.

In addition, the backrest angle adjustment handle of each of the front chair seat unit 320 and the rear chair seat unit 330 may be opened, and the angle adjustment belt 323 or 333 may be pulled and released to adjust and fix the backrest angle.

In addition, the shoulders, the waist, and the thighs of the baby are supported so as not to shake using the five-point coupling type safety belt provided at each of the front chair seat unit 320, the rear chair seat unit 330, and the front and the rear of the inside of the seat unit 300. As a result, the baby in the baby wagon 1 may maintain a comfortable posture, whereby the ride comfort of the baby may be improved while the baby wagon is stably moved.

Subsequently, any one of the wagon canopy unit 410 and the baby carrier canopy unit 420 is selectively coupled to the upper end of the foldable main body frame 100.

When the wagon canopy unit 410 is coupled, the upper end canopy mode 410a in which the canopy fixing poles 411 are fixed to the upper end according to the needs of the caregiver or the baby, or the lower end sunshade mode 410b in which the canopy fixing poles are fixed to the lower end according to the needs of the caregiver or the baby may be selected.

When use of the baby wagon 1 is completed, the baby is moved to a safe place, and the canopy unit 400, the tray unit 310, the front chair seat unit 320, and the rear chair seat unit 330 are separated from the foldable main body frame 100.

The front wheel unit 210 and the rear wheel unit 220 may be detached from the foldable main body frame 100 as needed.

Finally, the left and right folding handles of the baby wagon 1 are pulled upwards to release the locked state of the baby wagon 1, the foldable main body frame 100 is folded such that the side upper end frame 131 and the side lower end frame 132 are erected, and the baby wagon 1 is stored in the folding mode, in which the volume of the baby wagon 1 is minimized.

As is apparent from the above description, one or more embodiments of the present invention has the effect that the shapes of a frame and a seat of a baby wagon are varied to change the sitting direction and the sitting posture of a baby, whereby it is possible for the baby to maintain a comfortable posture depending on physical conditions of the baby, such as age and physical growth of the baby, and therefore ride comfort and transportation stability are improved.

In addition, one or more embodiments of the present invention have the effect that a change in shape of the baby wagon through folding and unfolding of the baby wagon is easily performed by a caregiver alone.

In addition, one or more embodiments of the present invention have the effect that the frame of the baby wagon is stably fixed for easy carrying and storage in a baby wagon folding mode and a baby wagon usage mode.

Although the one or more embodiments of the present invention have been disclosed for illustrative purposes, those skilled in the art will appreciate that various modifications, additions, and substitutions are possible, without departing from the scope and spirit of the invention as disclosed in the accompanying claims.

1. A baby wagon comprising:
a canopy assembly;
a seat assembly;
a wheel assembly; and
a foldable main body frame coupled to the canopy assembly and the seat assembly, wherein the foldable main body frame is configured to receive the seat assembly,
wherein the foldable main body frame comprises a front main frame, a rear main frame, and first and second side frames coupling the front main frame to the rear main frame,
wherein each of the first and second side frames includes a side upper end frame axially coupled to the front main frame and the rear main frame, a side lower end frame axially coupled to the front main frame and the rear main frame, and a vertical connection frame coupling the side upper end frame and the side lower end frame,
wherein the vertical connection frame includes an upper end central axis support fixture, a lower end central axis support structure, a side main frame, and a fixing frame, and
wherein the upper end central axis support fixture is formed at an upper end of the vertical connection frame and is connected to the side upper end frame at the front and rear thereof, and a folding handle configured to slidably move in an upward-downward direction is formed at an outer surface of the upper end central axis support fixture.

2. The baby wagon of claim 1, wherein the front main frame has a quadrangular structure disposed at a front end of the foldable main body frame in an upright state, and is configured to support a front of the foldable main body frame.

3. The baby wagon of claim 2, wherein the front main frame comprises a front upper end support fixture formed at a left side of an upper end of the front main frame and formed at a right side of the upper end of the front main frame in a symmetrical fashion, the front upper end support fixture being configured to support the front main frame.

4. The baby wagon of claim 3, wherein the front main frame further comprises a front center support fixture formed at each of left and right sides of a center of the front main frame in a symmetrical fashion, the front center support fixture being provided with a through-hole formed through one side of an outer part of the front center support fixture in a vertical direction, the through-hole having a circular step.

5. The baby wagon of claim 4, wherein the front main frame further comprises a front lower end support fixture formed at each of left and right sides of a lower end of the front main frame in a symmetrical fashion, the front lower end support fixture being configured to support the front main frame.

6. The baby wagon of claim 5, wherein the front main frame further comprises a front main support frame coupled to the front upper end support fixture and the front lower end support fixture formed in left-right symmetry so as to have a quadrangular shape, the front main support frame being configured to support the entirety of the front main frame.

7. The baby wagon of claim 6, wherein the front main support frame is coupled to left and right inner surfaces of the front upper end support fixture so as to support the front upper end support fixture in a horizontal state.

8. The baby wagon of claim 7, wherein the front main support frame is coupled to and separated from the front upper end support fixture, and is configured to be switched to a front exposed seat mode.

9. The baby wagon of claim 1, wherein the seat assembly includes a front seat assembly and a rear seat assembly.

10. The baby wagon of claim 9, wherein the seat assembly is selectively operated in a dual front seat mode in which the front seat assembly is located so as to face in a front direction and is fixed to one side of a center of an interior of the foldable main body frame by coupling between left and right coupling portions and in which the rear chair seat assembly is located so as to face in the front direction and is fixed to one side of a rear of the interior of the foldable main body frame by coupling between the left and right coupling portions.

11. The baby wagon of claim 9, wherein the seat assembly is selectively operated in a dual inner seat mode in which the front seat assembly is located so as to face in a rear direction and is fixed to one side of a front of the interior of the foldable main body frame by coupling between left and right coupling portions and in which the rear seat assembly is located so as to face in the front direction and is fixed to one side of the rear of the interior of the foldable main body frame by coupling between the left and right coupling portions.

12. The baby wagon of claim 9, wherein the seat assembly is selectively operated in a dual outer seat mode in which the front seat assembly is located so as to face in the front direction and is fixed to one side of the center of the interior of the foldable main body frame by coupling between the left and right coupling portions and in which the rear seat assembly is located so as to face in the rear direction and is fixed to one side of the center of the interior of the foldable main body frame such that a backrest of the rear seat assembly faces a backrest of the front seat assembly by coupling between the left and right coupling portions.

13. The baby wagon of claim 1, wherein the seat assembly comprises:
a front chair seat assembly coupled and fixed to one side of a front of an interior of the foldable main body frame; and
a rear chair seat assembly coupled and fixed to one side of a rear of the interior of the foldable main body frame,
wherein the front chair seat assembly is configured such that a zipper is formed at a boundary between each of left and right surfaces and a backrest so as to be opened and closed in a longitudinal direction, an angle adjustment belt is formed at centers of the left and right surfaces along peripheral surfaces thereof so as to extend to a center of the backrest at the rear such that the angle adjustment belt extends through a backrest angle adjustment portion, and the angle adjustment belt is secondarily pulled and released in a state in which a switch of the backrest angle adjustment portion is open, thereby an angle of the backrest is adjusted.

14. The baby wagon of claim 1, wherein:
the foldable main body frame comprises a front main frame; and
the canopy assembly is operated in an upper end canopy mode in which poles are inserted into and coupled to upper end coupling portions of the front main frame formed in left-right symmetry.

15. The baby wagon of claim 1, wherein:
the foldable main body frame comprises a front main frame; and
the canopy assembly is operated in a lower end sunshade mode in which poles are inserted into and coupled to upper end coupling portions of the front main frame formed in left-right symmetry and the poles are inserted into and coupled to lower end coupling portions of the front main frame.
